(19) United States
(12) Patent Application Publication
(10) Pub. No.: US 2006/0040901 A1
(43) Pub. Date: Feb. 23, 2006

(54) Derivatives of 1,3-cyclic propandiol phosphate and their action as cell stimulants

(75) Inventor: Meir Shinitzky, Kfar Shmaryahu (IL)

Correspondence Address: BROWDY AND NEIMARK, P.L.L.C.;624 NINTH STREET, NW, SUITE 300, WASHINGTON, DC, 20001-5303, US

(73) Assignee: YEDA RESEARCH AND DEVELOPMENT CO. Ltd., Rehovot (IL)

(21) Appl. No.: 10/507,490

(22) PCT Filed: Mar. 13, 2003
(86) PCT No.: PCT/IL03/00205

§ 371 Date: Aug. 22, 2005

(30) Foreign Application Priority Data
Mar. 13, 2002 (IL) 148665

(51) Int. Cl. A61K 31/66

(52) U.S. Cl. 514/109; 558/78

(57) ABSTRACT

The present invention discloses new cyclic glycerophosphates and cyclic popandiol phosphates and pharmaceutical compositions comprising said compounds for promoting neural activity such as neuronal outgrowth, nerve growth, prevention of nerve degeneration and nerve rescue.

### FIELD OF THE INVENTION

This invention relates to 1,3-cyclic propandiol phosphate derivatives, pharmaceutical compositions comprising them and use thereof as cell stimulants.

### PRIOR ART

The following is a list of references which is intended for a better understanding of the background of the present invention.
Boyd, R. K., De Freitas, A. S. W., Hoyle, J., McCulloch, A. W., McInnes, A. G., Rogerson, A. and Walter, J. A., J. Biol. Chem., 262:12406-12408 (1987).
Clarke, N. and Dawson, R. M. C., Biochem. J., 216:867-874 (1976).
Dawson, R. M. C., Ann. Rept. Progr. Chem. 55:365, (1958).
Dawson, R. M. C., Freinkel, N., Jungalwala, F. B. and Clarke, N., Biochem. J, 122:605-607, (1971).
Forrest, H. S. and Todd, A. R., J. Chem. Soc., 1950, 3925, (1950).
Friedman, P., Haimovitz, R., Marlanan, O., Roberts, M. F. and Shinitzky, M., Conversion of lysophospholipds to cyclic lysophosphatidic acid by phospholipase, D. J. Biol. Chem., 271:953-957 (1996).
Hagg, T. and Varon, S., Proc. Natl. Acad. Sci., USA 90:6315-6319, (1993).
Kennedy and Weiss, J. Biol. Clem., 222:193 (1956).
Knusel, B., et al., . Neurosci., 10:558-570, (1990).
Knusel, et al., Proc. Natl., Acad. Sci. USA, 88:961-965 (1991).
Leloir, L. F., Biochem. Biophys., J., 33:186 (1951).
Linn, L. F. H., et al., Science, 260:1130-1134 (1993).
Markham, R. and Smith, J. D., Biochem. J., 52:552-(1952).
Shinitzky, M., Friedman, P. and Haimovitz, R., Formation of 1,3-cyclic glycerophosphate by the action of phospholipase C on phosphatidylglycerol, J. Biol. Chem., 268:14109-14115 (1993).
Shinitzky, M, Haimovitz, R, Nemas, M, Cahana, N, Mamillapalli, R, Seger, R (2000) Induction of intracelluar signalling by cyclic glycerophosphates and their deoxy analogues. Eur. J. Biochem. 267: 2547
Su, B., Kappler, F., Szwergold, B. S. and Brown, T. R., Cancer Res., 53:1751-1754, (1993).
Tomac, A., et al., Nature, 373:335-339 (1995).
Ukita, T., Bates, N. A. and Carter, H. E., J. Biol. Chem., 216:867-874, (1955). Shinitzky, M. WO 00/57,865.

### BACKGROUND OF TH)I INVENTION

L-α-glycerophosphate (αGP), a key constituent in phospholipid metabolism (Kennedy and Weiss, 1956), is abundant in most biological tissues (Dawson, 1958). β-Glycerophosphate (βGP) is a product of enzymatic (Ukita et al., 1955) and alkaline (Clarke and Dawson, 1976) hydrolysis of phospholipids and is formed through the cyclic phosphodiester intermediate 1,2-cyclic glycerophosphate (1,2 cGP) (Ukita et al., 1955; Clarke and Dawson, 1976). 1,2 cGP has been detected in algae species (Boyd et al., 1987) as well as in human cancer tissues (Su et al., 1993). Similarly, αGP can in principle adopt the cyclic form 1,3-cyclic glycerophosphate (1,3 cGP). This compound has been shown to be formed as an intermediate in the phospholipase C hydrolysis of phosphatidyl glycerol (PG) (Shinitzky et al., 1993) and upon further hydrolysis is converted to αGP.
X′ is hydrogen or CH₂OH;
Y is O—R₁, NH—R₁;
R is hydrogen, linear or branched alkyl, linear or branched acyl, substituted or non-substituted aryl or araalkyl residue;
R₁ is hydrogen, linear or branched alkyl, linear or branched acyl, substituted or non-substituted aryl, alkylcarboxy ester or alkyl-N—R₂R₃;
R₂ and R₃ are independently hydrogen or an alkyl group;
provided that X and X′ can not both be hydrogen when X is NH—R where R is a linear or branched acyl Y is not OR₁ for R₁ being a 4-nitrophenyl; and provided that when X′ is CH₂OH ten X is NH—R or NO₂.

As used herein the term “alkyl” refers to an alkyl group having from 1 to 24 carbon atoms, e.g preferably from 3 carbon atoms to 20 carbon atoms, most preferably from 5 carbon atoms to 15 carbon atoms; the term “acyl” refers to an aliphatic saturated or unsaturated C₁-C₂₄ acyl group, preferably an acyl group having, an even number of carbon atoms, most preferably an aryl group derived from a natural fatty acid such as a saturated aliphatic acyl group selected from acetyl, butyryl, caproyl, octanoyl, decanoyl, lauroyl, myristyl, palmitoyl and stearoyl, or an unsaturated aliphatic acyl group selected from palmitoleyl, oleyl, linoleyl, and ricinoleyl; and the term “aryl” refers to a mono- or poly-carbocyclic aryl group, most preferably phenyl, optionally substituted by C₁-C₄ alkyl, halogen and/or hydroxy.

In one embodiment Y is a hydroxyl group and X is O-oleoyl, O-benzyl, O—CH₂COOCH₂CH₃, NH-benzyl or NH-caproyl.

In another embodiment X is hydrogen and Y is O-acetyl or NH—CH₃.

The present invention further provides a pharaceutical composition comprising a pharmaceutically acceptable carrier and, as an active ingredient a compound of the general formula I. A preferred use of said composition is for stimulation of target cells.

The CPP used in the invention may exert one of many neutral promoting activities including but not limited to promotion of neutronal outgrowth, promotion tyrosine hydroxylase (TH), the key enzyme in the dopamine production pathway immunoreactvity when treated with factors like GDNF (Tomac, A. et al. 1995) and ciliary neurotrophic factor (CNTF) (Hagg, T. and Varon 1993).

Glossary

The following is an explanation of some terms used above and in the following description and claims:

CPP—the 1,3-cyclic propandiol phosphates derivatives used in the present invention.

Target cells—any cells, which have the potential to mature into neural cells. Non-limiting examples of such cells are PC12 and primary brain cells.

Substantially maintaining—this term relates to the capability of analogs to promote the activity carried out by the cyclic glycerophosphate from which they were derived to a certain extent. The analog's activity will be considered to be substantially maintained wherein the activity is 30% or above, preferably 50% or above, more preferably 70% or above, and most preferably 90% or above the level of the activity of the cyclic glycerophosphate.

Effective amount—wherein the method of the invention is intended for prevention of a non-desired condition, the term “effective amount” should then be understood as meaning an amount of the active compound which, when administered to an individual, results in the prevention of the appearance of the said condition. Prevention of such a condition, e.g. a neurodegenerative condition, may be required prior to the appearance of any symptoms of a disease, e.g. in individuals having a high disposition of developing the disease, or when the compositions are used for the treatment of nerve rescue which is expected after nerve injury. Wherein the compositions or methods are intended for treatment of an ongoing non-desired condition, the term “effective amount” should then be understood as meaning an amount of the active compound which is effective in ameliorating or preventing the enhancement of the treated condition and related symptoms.

Neutral promoting activity—this term encompasses a variety of neutral related activities which may be promoted in target cells upon their contact with the CPP used in the invention. Such activities include but are not limited to promotion of nerve growth, provision of dopaminotrophic supporting environment in a diseased brain, prevention of nerve degeneration, and nerve rescue.

Prevention or treatment—the term prevention of disorders or diseases is to be understood in accordance with the invention as a reduction in the probability of the appearance of such disorders or diseases in an individual having a high predisposition of developing such disorders or diseases, reducing the extent of the symptoms associated with such disorders and disease when they occur or completely preventing their appearance.

### SUMMARY OF THE INVENTION

In accordance with the invention new derivatives of 1,3-cyclic propandiol, phosphate are provided that are capable of stimulating cells.

The present invention thus provides, by a first of its aspects, a compound of formula I 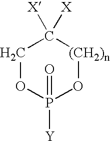
or pharmaceutically acceptable salts, thereof,
wherein
n is 1;
X is hydrogen O—R, NH—R, NO_{z}, or N—(C═O)—R;
X′ is hydrogen or CH₂OH;
Y is O—R₁, NH—R₁;
R is hydrogen, linear or branched alkyl, linear or branched acyl, substituted or non-substituted aryl or araalkyl residue;
R₁ is hydrogen, linear or branched alkyl, linear or branched acyl, substituted or non-substituted aryl, alkylcarboxy ester or alkyl-N—R₂R₃;
R₂ and R₃ are independently hydrogen or an alkyl group;
provided that X and X′ can seat not both be hydrogen; when X is NH—R where R is a linear or branched acyl Y is not OR₁ for R₁ being a 4-nitrophenyl; and provided that when X′ is CH₂OH n X is NH—R or NO₂.

As used herein the “alkyl” refers to an alkyl group having from 1 to 24 carbon atoms, e.g. Preferably from 3 carbon atoms to 20 carbon atoms, most preferably from 5 carbon atoms to 15 carbon atoms; the term “acyl” refers to an aliphatic saturated or unsaturated C₁-C₂₄ acyl group, preferably an acyl group having an even number of carbon atoms, most preferably an acyl group derived from a natural fatty acid such as a saturated aliphatic acyl group selected from acetyl, butyryl, caproyl, octanoyl, decanoyl, lauroyl, myristyl, palmitoyl and stearoyl, or an unsaturated aliphatic acyl group selected from palmitoleyl, oleyl, linoleyl, and ricinoleyl; and the term “aryl” refers to a mono- or poly-carbocyclic aryl group, most preferably, phenyl optionally substituted by C₁-C₄ alkyl, halogen and/or hydroxy.

In one embodiment, Y is a hydroxyl group and X is O-oleoyl, O-benzyl, O—CH₂COOCH₂CH₃, NH-benzyl or NH-caproyl.

In another embodiment X is hydrogen and Y is O-acetyl or NH—CH₃.

To present invention further provides a pharmaceutical composition comprising a pharmaceutically acceptable carrier and, as an active ingredient, a compound of the general formula I. A preferred use of said composition is for stimulation of target cells.

The CPP used in the invention may exert one of many neural promoting activities including but not limited to promotion of neuronal outgrowth, promotion of nerve growth, provision of dopaminotrophic supporting environment in a diseased portion of the brain, prevention of nerve degeneration and nerve rescue. All these activities fall within the scope of neural promoting activity.

Thus, the present invention also provides a pharmaceutical composition for promoting neural activity comprising a pharmaceutical acceptable carrier and, as an active ingredient, a compound of the general formula I above.

The ability of the pharmaceutical compositions of the invention to promote neuronal activity in one or more of the above ways renders them extremely useful for treatment of various disorders. Thus, the invention also provides a pharmaceutical composition comprising a pharmaceutically acceptable carrier and, as an active ingredient, a compound of the general Formula I above, for the prevention or treatment of disorders and diseases which can be prevented or treated by promoting neural activity.

Such disorders may be mental disorders such as, for example, schizophrenia or dementia or disorders resulting in learning disabilities.

In addition, the pharmaceutical compositions of the invention may also be used for the treatment of neurodegenerative conditions involving damage to dopaminergic neural cells. Examples of such conditions are Alzheimer's disease (AD) or Parkinson's disease (PD).

Additional neurodegenerative conditions which are within the scope of the present invention are such which result from exposure of an individual to harmful environmental factors such as hazardous chemicals, neurodegenerative conditions resulting from a mechanical injury (e.g. injury of the optical nerve resulting from contact of the eye with an abusive external factor), etc.

Furthermore, it is known that, following primary degeneration of nerves, additional nerves present in the vicinity of the degenerated nerves undergo secondary degeneration. Treatment of an individual suffering from a primary neurodegenerative condition may prevent or reduce the appearance of secondary degeneration in additional nerves present in the vicinity of the degenerated nerves. Such treatment, termed “nerve rescue” is also within the scope of the present invention.

Said period of time is such a period, which enables the compositions of the invention to exert their activity. This period of time may easily be determined by a person skilled in the art for each kind of composition and target cells using any of the methods described herewith. Typically, and in contrast to some known factors which affect neural cells such as NGF, the period of time required for the CPP used in the invention to be in contact with the target cells in order to exert their effect is very short (several minutes).

In accordance with an additional aspect of the invention, a method is provided for promoting neural activity in an individual comprising administering to the individual in need an effective amount of a compound of the general Formula I above.

A method for the prevention or treatment of disorders and diseases which can be prevented or treated by promoting neural activity is also provided. This method comprises administering to a person in need a therapeutically effective amount of a compound of Formula I above.

The method of the invention may be used for the treatment of a variety of disorders and diseases in which the above mentioned effects are beneficial, i.e., in which the effect of the CPP ameliorates or reduces the undesired symptoms of the treated condition or disease. These conditions and disorders may be for example, but not limited to, mental disorders such as schizophrenia or dementia, disorders leading to learning disabilities, neurodegenerative disorders such as Alzheimer or Parkinson disease and for prevention or treatment of nerve rescue following nerve injury.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 shows photographs of levels a series of proteins from CHO cells which were tyrosine, phosphorylated following the incubation of the cells with the compound 1,3 cyclic propandiol phosphate-2-methylamine of the present invention.

FIGS. 2A and 2B show a comparison between a control (A) and treated cells (B) indicating induction of neuronal outgrowth in PC-12 cells after incubation in tissue culture with the compound β-caproylamido 1,3-cPP of the present invention compared to such cells incubated with a control.

FIG. 3 shows the length of axon plexus (μm) after treatment of pyramidal rat embryo hippocampell cells with 5 μM 1,3cPP for three days compared to untreated cells.

FIG. 4 shows the length of the longest axon (μm) after treatment of pyramidal rat embryo hippocampell cells with 5 μM 1,3cPP for three days compared to untreated cells.

FIG. 5 shows number of axonal branch points per cell treated with μM 1,3cPP compared to non-treated.

### DETAILED DESCRIPTION OF THE INVENTION

As mentioned, the present invention provides cyclic glycerophosphates (CGs), and in particular derivatives of 1,3-cyclic propandiol phosphates (CPP). These new derivatives may be used for stimulating cells. In particular, the CPP of the present invention promote neural activity. Neural activity is shown as induction of neuronal outgrowth and axonal elongation and branching. The hippocampus for example is a source of a relatively homogeneous population of neurons with well-characterized properties typical of CNS neurons. The main cell type in the hippocampus is the pyramidal cell. This cell has a well-defined shape: one single axon and several dendrites. The hippocampal neurons have 5 developmental stages.

At stage 3 one of the processes begins to elongate and acquires axonal characteristics. At this stage, the axon can be distinguished from the other processes. Measuring the effect of adding 13,CPP to pyramidal cell as stage 3 differentiation showed that such incubation resulted in lengthening of the total axon plexus, lengthening of the longest axon and increase in the number of axonal branch points per cell.

Such promoting of the neural activity has therapeutic implications. The resulting induced cell activity may be used in neurodegenaration. The 1,3-cyclic propandiol phosphates and analogs thereof of the invention may generally be synthesized using any one of the methods known in the art for synthesis of phosphate esters. Specific methods, which may typically be used, for preparing the cyclic phosphates of the invention are described specifically below (see Examples).

In the case of using the new CPP of the present invention for promoting neural activity, suitable pharmaceutical compositions comprising as the active ingredient an efficient amount of the CPP are prepared. In addition to the active ingredient, the pharmaceutical compositions may also contain a carrier selected from any one of the carriers known in the art. The nature of the carrier will depend on the intended form of administration and indication for which the composition is used. The compositions may also comprise a number of additional ingredients such as diluents, lubricants, binders, preservatives, etc.

The compositions of the invention may be administered by any suitable way. A preferred mode of their administration is either i.v., topically or per os although at times it may be advantageous to use other administration modes as well.

Typically, the pharmaceutical compositions of the invention will comprise about 1 mg to about 100 mg of the active material per kg body weight of the treated individual.

While the compositions of the invention will typically contain a single CPP, it is possible at times to include in the composition or to co-administer two or more CPP, which may then act together in a synergistic or additive manner to prevent or treat the neurogenerative disorder.

The CPP used in the invention may be used in any of their isomer forms. For various purposes, one of the isomers may be preferred over the remaining ones.

According to the invention, the CPP may be administered either in a single dose or may be given repetitively over a period of time.

The compositions of the invention may also be administered to the treated individual in combination with an additional treatment, e.g. wherein the treated condition is a neurodegenerative one, the compositions may be given together with one of the currently available drugs or therapies used for treatment of neurodenerative diseases such as dopamine receptor stimulants, L-dopa or together with a growth factor such as NGF. In such a combination treatment the CPP may be administered simultaneously with or at different times than the administration of the additional treatment so as to yield a maximum preventive or therapeutic effect.

Furthermore, it should be noted that 2-dimethylamine ethyl ester 1,3-cyclic propanediol phosphate (described in Example 12 below) was designed for crossing the blood brain barrier and tests revealed that the compound is indeed able to cross the blood brain barrier. Thus such a compound may be useful for treating neurodegenerative symptoms in the central nervous system as well.

### EXAMPLES

The invention will now be illustrated by the following non-limiting examples.

Chemical Synthesis

1,3 cyclic propandiol phosphate. This compound (1,3-cPP) was prepared by the procedure described (Shinitzki et al. 2000) and was dissolved in Hanks' balanced salt solution (HBSS) or cell culture medium and sterilized by filtration.

Additional cyclic phosphates of the invention are prepared using various starting materials for forming the 1,3-cyclic propandiol moiety substituted with the appropriate derivatives. The reaction of a suitable μ-glyceryl derivative (oleoyl, benzyl) with POCl₃, gives the desired cyclization and yields the oleoyl and benzyl derivatives, respectively of the 1,3-cyclic propandiol ring. Serinol (2-amino-1,3-propandiol) or 1,3-cyclic propandiol phosphatre are also used as starting materials for the synthesis of other derivatives as described below.

The reaction is carried out in an anhydrous solvent, e.g. dioxane or methylene chloride. The synthesis of a series of novel 6-membered ring cyclic phosphates is illustrated below.

General

Free phosphates (either the acid form or the sodium salt) were prepared by the following general procedure involving the preparation of Solutions a-d:

Solution a: 0.1M of the dialcohol dissolved in freshly distilled methylene chloride.

Solution b: 0.1M of freshly distilled phosphorous oxichloride (POCl₃, 15, 35 gr or 9.35,1) dissolved in freshly distilled methylene chloride.

Solution c: Acetone-Water 9:1 (v/v).

Solution d: Acetone-0.1M aqueous sodium bicarbonate.

Procedure: To a cooled (4° C.) solution a, an equi-volume of solution b was added dropwise while stirring. The temperature was then slowly raised to boiling and allowed to reflux for 406 hours. The solvent was evaporated. The residue was dissolved either in solution c (to obtain the free acid) or solution d (to obtain the sodium salt). After 24 hours the solvent was evaporated yielding the desired crude product. Recrystalization was done from either acetone or acetonitirile.

Phosphate esters and phosphateamidates were prepared as mentioned above with the following modification. At the last step, the phosphorous monochloride derivative was further reacted in methylene chloride with an alcohol (e.g. benzyl alcohol) to obtain the respective ester of the cyclic phosphate. Alternatively it may be reacted with a primary or secondary amine and an equivalent of triethylamine to obtain the phosphoamidate of the cyclic phosphate. After evaporation the crude product was recrystallized from a water/ethanol solution.

### Example 1

### Synthesis of 1,3-cyclic propandiol phosphate-5-oleoyl

β-glyceryl mono oleate (Sigma) was reacted with equimolar amount of POCl₃ in freshly distilled dry CH₂Cl₂ under reflux for 8 hours. Hydrolysis of the remaining P—Cl bond was afforded by evaporating the solvent and redissolving the residue in acetone-aqueous sodium bicarbonate 9:1 (v/v). After 24 hour the solvent was evaporated and the product was purified by chromatography on silica gel with mixtures of chloroform-methanol-water as eluants.

### Example 2

### Synthesis of 1,3-cyclic propandiol phosphate-5-benzyloxy

β-benzyl glycerol (Sigma) was reacted with equimolar amount of POCl₃ analogously to Example 1 and purified by thin layer chromatography (TLC) of silica gel.

### Example 3

### Synthesis of 1,3-cyclic propandiol phosphate-5-benzylamino

Serinol (Aldrich) was reacted with benzyl bromide in dry CH₂Cl₂. The product (N-benzyl serinol) was reacted with POCl₃ as in Example 1. Purification was afforded by silica gel chromatography.

### Example 4

### Synthesis of 1,3-cyclic propandiol phosphate-5-caproylamido

Caproic acid (Aldrich) and N-hydroxy succinimide (Aldrich) were reacted with dicyclohexyl carbodiimide (DCC, Aldrich) in ethyl acetate. The formed active ester caproyl hydroxy succinimide was collected in the supernatant. It was further reacted with serinol (Aldrich) in tetrahydrofuran (THF) −0.1 M aqueous sodium bicarbonate 1:1 (V/V). The obtained caproyl amide of serinol was isolated and reacted with POCl₃ as in example 1. The product was isolated by TLC on silica gel.

### Example 5

### Synthesis of 1,3-cyclic propandiol phosphate-2-benzyloxy

Benzyl dichlorophosphate was prepared by mixing equimolar amounts by benzyl alcohol with POCl₃ for 1 hour at room temperature. Then one equivalent of 1,3 propanediol (Aldrich) in dry CH₂Cl₂ was added and allowed to react by reflux for 18 hours. One volume of aqueous 0.1M NaHCO₃ was then added and mixed. The CH₂Cl₂ layer which contained the product was separated and washed several times with water. The CH₂Cl₂ was evaporated and the product (oil) was collected.

### Example 6

### Synthesis of 1,3-cyclic propandiol phosphate-2-acetyloxy

1,3 Cyclic propanediol phosphate (1,3 cPP (Shinitzky et al. 2000 Eur. J. Biochem. 267:2547) was dissolved in acetic acid and diluted with an excess of acetic anhydride (Aldrich). The mixture was refluxed for 8 hours and then evaporated under vaccum. The product, a mixed anhydride of 1,3 cPP and acetic acid, remained as oil.

### Example 7

### Synthesis of 1,3-cyclic propandiol phosphate-2-methylamino

1,3 Propanediol was reacted with equimolar amounts of POCl₃ for 5 hours in CH₂Cl₂ to yield 1,3 cyclic chloropropanediol (1,3 cPP-Cl, Shinitzky et al., 2000). The solvent was evaporated and the product extracted with ether. 1,3 cPP-Cl was dissolved in tetrahydrofuran (THF) and reacted with methylamine gas for 5 hours. The THF was evaporated, the precipitate collected and the final product crystallized from isopropanol.

The compound was pure on a thin layer chromatography (n-propanol: NH₃: water, 6:3:1, Rf 0,7) and mass spectra analysis gave the predicted molecular weight.

### Example 8

### Synthesis of 1,3-cyclic propandiol phosphate-5-glycine ethylester

1,3 cPP-Cl synthesized as described above was reacted with equimolar amounts of glycine ethylester and triethylamine in THF for 24 hours. The THF was evaporated and the precipitate collected. The final product was extracted with ether.

The compound was pure on a thin layer chromatography (chloroform: ethanol: water, 68:25:4, Rf 0,76) and mass spectra analysis gave the predicted molecular weight.

### Example 9

### Synthesis of 1,3-cyclic propanediol phosphate

0.5 M solution of 1,3-propanediol (Aldrich) in freshly distilled methylene chloride was cooled to 4° C. To this solution, an equimolar amount of freshly distilled POCl₃ dissolved in methylene chloride was added dropwise with stirring. The temperature was then raised slowly to boiling and kept under reflux for 6 hours. The solution was then evaporated to complete dryness and acetone-water (9:1) was added. The solution was left at room temperature for 24 hours and then evaporated to dryness to obtain the acid form of the product. Crystallization was afforded from acetone or acetonitrile.

### Example 10

### Synthesis of 2-methyl 1,3-cyclic propanediol phosphate

0.5 M solution of 2-methyl 1,3-propanediol (Aldrich) was reacted with an equimolar amount of POCl₃ as in Example 9.

### Example 11

### Synthesis of 1-methyl 1,3-cyclic propanediol phosphate

0.5 M solution of 1,3-butanediol (Aldrich) was reacted with an equimolar amount of POCl₃ as in Example 9.

### Example 12

### Synthesis of 2-dimethylamine ethyl ester 1,3-cyclic propanediol phosphate

Distilled and dry 2-dimethylamine ethanol (Aldrich) was dissolved in dry methylene chloride and an equimolar amount thereof was added to 1,3-cyclic propanediol phosphate (prepared according to Example 9) in methylene chloride and refluxed for 4 hours. Upon cooling the hydrochloride salt of the product precipitated. The compound was crystallized from ethanol.

### Example 13

### Synthesis of 1,3-cyclic propanediol phosphoamidate

1,3-propanediol was reacted with an equimolar amount of phosphorus oxychloride in methylene choride and the resulting 1,3-cyclic-propanediol phosphate-Cl was reacted with ammonia gas, yielding 1,3-cyclic-propanediol phosphate-NH₂. The compound was pure on thin layer chromatography (n-propanol: NH₃: H₂O 6: 3: 1 v/v, Rf 0.63).

### Example 14

### Synthesis of 1,3-cyclic propanediol N-ethyl phosphoamidate

1 equivalent of 1,3-cyclic-propanediol-phosphate-Cl as prepared in the preceding example, was reacted with an equivalent of ethylamine in the presence of equivalent of triethylamine in tetrahydrofuran. Final product was pure on TLC (n-propanol: NH₃: H₂O 6: 3: 1 v/v).

### Example 15

### Synthesis of 1,3-cyclic propanediol phosphoamidate glycine ethylester

1 equivalent of 1,3-cyclic-propanediol-phosphate-Cl as prepared in Example 13, was reacted with glycine ethylester hydrochloride in the presence of 2 equivalents of triethylamine. The final product was pure on TLC (chloroform: methanol: water 65:25:4 v/v, Rf 0,76).

### Example 16

### Synthesis of 2-benzyloxy 1,3-chloropropanediol phosphate

2-benzyloxy 1,3 propanediol (Aldrich) was reacted in equimolar amounts with phosphorus oxychloride in methylene chloride. Benzoxy 1,3-cyclic propanediol phosphate was pure on TLC (n-propanol: NH₃: H₂O 6: 3: 1 v/v, Rf 0.63).

### Example 17

### Synthesis of 2-caproimido 1,3-chloropropanediol phosphate

Caproic acid was reacted overnight with N-hydroxy succinimide (NHS) in the presence of DCC in equimolar amounts. The obtained precipitate, DCU, was separated and discarded, and the caproic acid-NHS ester was extracted from the supernatant. This compound was dissolved in THF and reacted overnight with 1 equivalent of serinol dissolved in 0.1 M NaHCO₃. The solvent was evaporated and the amide of caproic acid-serinol extracted with ethyl acetate and then reacted with phosphorous oxychloride in methylene chloride. The final product was pure on TLC (chloroform:methanol:water 65:25:4 v/v, Rf 0.83).

### Example 18

### 5-Amino-5-hydroxymethyl-2-oxo-2λ5-[1,3,2]dioxaphosphinan-2-ol:

Trihydroxymethylaminomethane was dissolved in water. The aqueous solution was brought to dryness over silica. The adsorbed trihydroxymethylaminomethane was placed in anhydrous CH₂Cl₂ and an equivalent amount of POCl₃ was slowly added (dropewise). The combined solution was stirred in reflux (ca. 40° C.) for several days until HCl fumes were not detected. CH₂Cl₂ was evaporated, water were added, the solution brought to dryness and the product isolated.

### Example 19

### 5-Nitro-5-hydroxymethyl-2-oxo-2λ5-[1,3,2]dioxaphosphinan-2-ol:

The compound was synthesized in a manner similar to the compound in Example 18, where the starting material was Trihydroxymethylnitromethane.

Biological Activity

PC12 Cells

The immortal PC12 cell line is one of the most investigated systems in neuronal differentiation. In the presence of nerve growth factor these cells differentiate to neuronal cells. PC12 cells originated from rat pheochromocytoma were grown as monolayers in Eagle's medium (EM) supplemented with 10% fetal calf serum, 50 μg/ml gentamicin and 5 mM glutamine, in a humidified incubator buffered with 5% CO₂, at 37° C. The culture medium is changed every four days and the cells are passaged every eight days and performed confluent monolayers (1.5×10⁶ in a 10 cm plate or 10⁵ cells per well in 24 wells plate). PC12 cells are originally round cells which, following several days in the presence of nerve growth factor (NGF) process nerves. Upon withdrawal of the NGF, the nerves retract and a process of apoptosis is initiated in the cells.

Neuronal Cultures in Hyppocampel Cells

Rat hippocampal neurons were cultured at low density in defined medium as described previously (Brann et al., 2002, J Bio Chem 277(12): 9812-9818), with slight modifications. Briefly, the dissected hippocampi of embryonic day 18 rats were dissociated by trypsinization (0.25% w/v, for 15 min at 37° C.). The tissue was washed in Mg²⁺/Ca²⁺-free Hanks' balanced salt solution (Invitrogen) and dissociated by repeated passage through a constricted Pasteur pipette. Cells were plated in minimal essential medium with 10% horse serum at a density of 25,000 cells per 13-mm glass cover slips that had been precoated with poly-L-lysine (1 mg/ml). After 2-4 hr, cover slips were transferred into 24-well plates (Nunc), containing B27 supplemented Neurobasal medium (Brewer, G. et al., 1993, J Neurosci Res 35: 567-576), and cultures were maintained in this defined medium throughout the experiment. Cyclic phosphate compounds were dissolved in either ethanol or dimethylsulfoxide (the final ethanol or DMSO concentration did not exceed 0.1% (v/v)) and were added to cultures immediately after transferring the cover slips to the 24 well plates to give final concentrations as indicated below.

### Example 20

### Cell Signaling Analysis

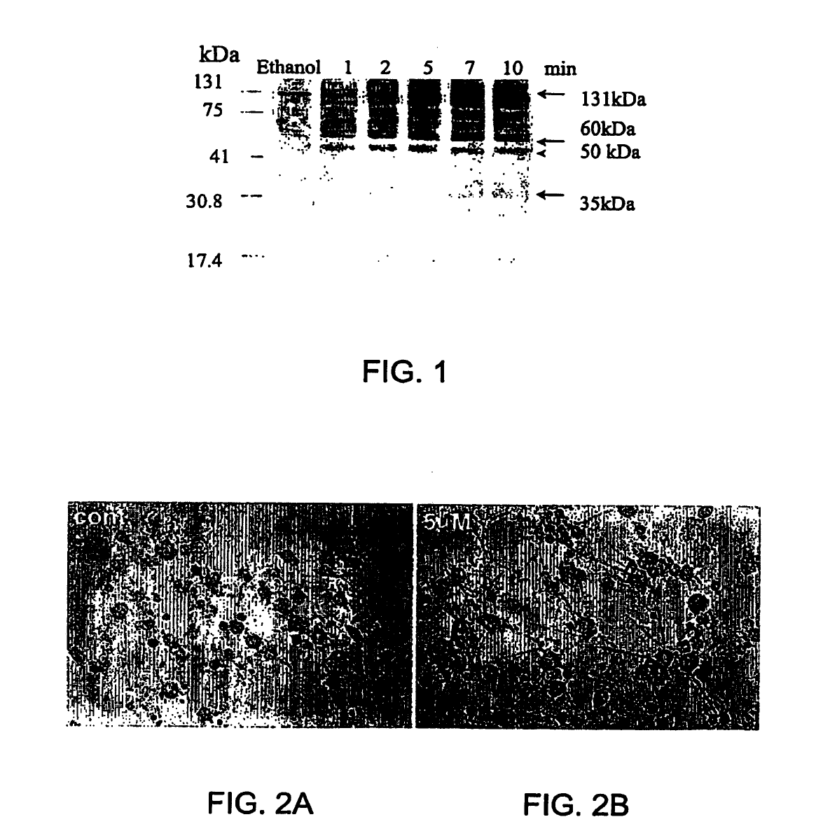

CHO cultures were grown as described above for PC12 cells. The cultures were divided into two groups and different compounds were added, followed by a period of incubation of from 1 to 30 minutes. Thus one CHO culture was incubated with 5 μM of 1,3-cyclic propandiol phosphate-2-methylamino at 37° C., the control being a similar CHO culture incubated with 1,3-cyclic glycerphosphate under the same conditions. Augmented tyrosine phosphorylation, noticed already after 1 minute of exposure, was induced by the presence of 1,3-cyclic propandiol phosphate-2-methylamino. In particular it was detected in a series of proteins with molecular weight of ≈35 kDa, ≈45 kDa, ≈60-70 kDa. as shown in FIG. 1.

### Example 21

### Induction of Neuronal Outgrowth in PC-12 Cells

PC12 cells were grown in culture as explained above. The cells were divided into two groups and different compounds were added. To the first were added 5 μM 1,3-cyclic propandiol phosphate-5-caproylamido, while as a control to the second portion was added NGF. After a period of 8 days the two groups of PC12 cells were inspected by microscope. As shown in FIG. 2, comparison of the two PC12 cells reveals that the addition of 1,3-cyclic propandiol phosphate-5-caproylamido to the cells promoted neural outgrowth (2B) while the line growth of the cells in which NGF was added did not exhibit such promotion of neural outgrowth (2A).

Similar effects were observed (data not shown) for the following compounds. 1,3-Cyclic propanediol phosphate, 2-methyl 1,3-cyclic propanediol phosphate and 1-methyl 1,3-cyclic propanediol phosphate (Examples 9-11 above) all of which exhibited similar activity in intracellular tyrosine phosphorylation (with Chinese Hamster Ovarian Cells, CHO cells), triggering axonal outgrowth in PC12 cells.1,3-cyclic propanediol phosphoamidate (Example 13 above) was shown capable of inducing tyrosine phosphorylation in CHO cells, but did not induce neuronal differentiation in PC12 cells. On the other hand it did rescue them from NGF deprivation. 1,3-Cyclic propanediol N-ethyl phosphoamidate (Example 14 above) promoted tyrosine phosphorylation, in CHO cells but did not induce neuronal differentiation of PC12 nor rescue from NGF deprivation. 2-Benzyloxy 1,3-chloropropanediol phosphate (Example 16 above) was dissolved in ethanol and from there introduced by 1:1000 dilution into PC12 cultures. Strong neuronal differentiation and nerve rescue was noticed. 2-Caproimido 1,3-chloropropanediol phosphate (Example 17 above) induced tyrosine phosphorylation in CHO cells and neuronal differentiation of PC12 cells.

### Example 22

### Neuronal Morphology

For morphological analysis, cover slips were removed from the 24-well plates on the 3^{rd} day of culture. Neurons were fixed in 1% (v/v) glutaraldehyde in phosphate-buffered-saline for 20 min at 37° C., and mounted for microscopic examination in 50% glycerol in phosphate-buffered-saline. Neurons were examined by phase contrast microscopy using an Achroplan 32x/0.4 n.a. phase 2 objective of a Zeiss Axiovert 35 microscope. Neuronal growth was analyzed based on established developmental criteria of cultured hippocampal neurons (Schwarz et al., 1995, J Bio Chem 270(18): 10990-10998; Brann et al., 1999, J Neurosci 19(19): 8199-8206) as follows: (i) Only neurons at stage 3 were analyzed in this study. A neuron was considered to be in stage 3 when the major axonal process was ≧30 μm (i.e., ˜10 μm longer than the next longest minor process). (ii) The length of the total axon plexus includes the length of the longest axon and all axonal branches. (iii) Only those cells in which the whole axon plexus could be unambiguously delineated were measured. (iv) The number of axonal branch points per cell were measured. An axon was considered to branch when the process that it gave rise to was >15 μm long. Thin filipodia, which were occasionally observed along the entire length of the axon, were not considered as branches.

Images of neurons were acquired using NIH image (version 1.62) software. The analyze mode was set to a proportional ratio scale of pixel to μm, the outline of the neuron was copied using the freehand line tool, and the line length measured and analyzed according to the morphological criteria outlined above. Values were pooled from a number of separate cultures and statistical analysis performed using the Student's t-test.

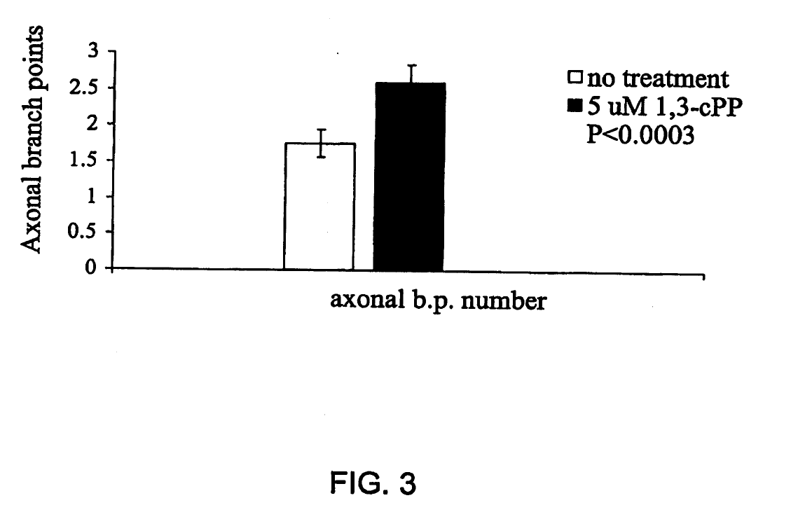

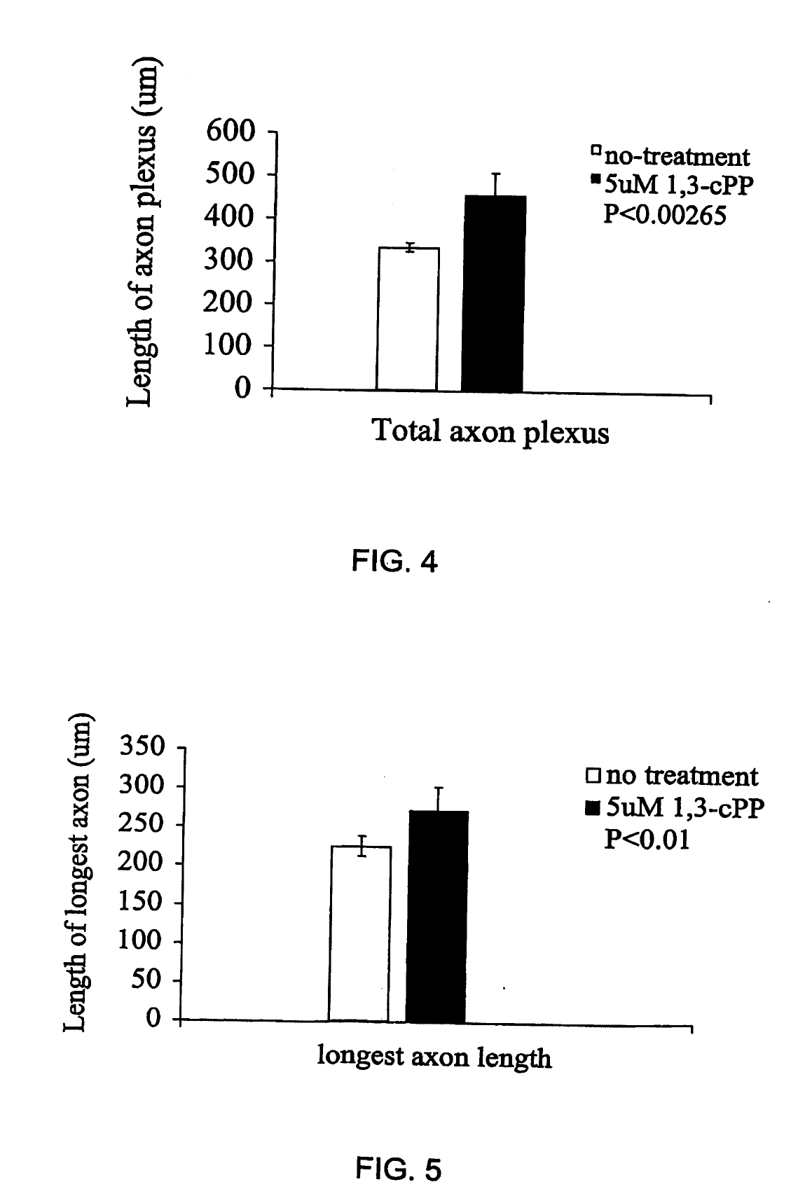

FIG. 3 clearly demonstrates that the total elongation of axon plexus in the treated hyppocampel cells is 32% compared to non-treated hyppocampel cells. The longest axon (main axon) has increased its length by about 20% in the treated cells compared to non-treated cells as shown in FIG. 4. Furthermore, FIG. 5 demonstrates that the treated hyppocampel cells have an increase of about 47% in branch points per cell compared with non-treated hyppocampel cells.

1-14. (canceled)

15. A compound of the following formula (I): 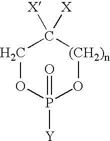
or a pharmaceutically acceptable salt thereof,
wherein:
n is 1;
X is hydrogen, O—R, NH—R, NO₂, or N—(C═O)—R;
X′ is hydrogen or CH₂OH;
Y is O—R₁, NH—R₁;
R is hydrogen, linear or branched alkyl, linear or branched acyl, substituted or non-substituted aryl or aralkyl residue;
R₁ is hydrogen, linear or branched alkyl, linear or branched acyl, substituted or non-substituted aryl, alkylcarboxy ester or alkyl-N—R₂R₃;
R₂ and R₃ are independently hydrogen or an alkyl group;
alkyl is an alkyl group having from 1 to 24 carbon atoms, preferably from 3 carbon atoms to 20 carbon atoms, most preferably from 5 carbon atoms to 15 carbon atoms;
wherein acyl is an aliphatic saturated or unsaturated C₁-C₂₄ acyl group, preferably an acyl group having an even number of carbon atoms, and most preferably an acyl group derived from a natural fatty acid such as a saturated aliphatic acyl group or an unsaturated aliphatic acyl group; and
aryl is a to a mono- or poly-carbocyclic aryl group, most preferably phenyl, optionally substituted by C₁-C₄-alkyl, halogen and/or hydroxy;
provided that X and X′ cannot both be hydrogen; that when X is NH—R, where R is a linear or branched acyl, then Y is not OR₁ where R₁ is a 4-nitrophenyl; and that when X′ is CH₂OH, then X is NH—R or NO₂.

16. A compound according to claim 15, wherein the acyl moiety is selected from the group comprising of acetyl, butyryl, caproyl, octanoyl, decanoyl, lauroyl, myristyl, palmitoyl and stearoyl, palmitoleyl, oleyl, linoleyl, and ricinoleyl.

17. A compound according to claim 15 wherein Y is OH and X is O—R or NH—R; wherein R is a linear or branched alkyl or linear or branched acyl.

18. A compound according to claim 15 wherein X is hydrogen and Y is O—R₁ or NH—R₁; wherein R₁ is a linear or branched acyl.

19. Compounds of formula I according to claim 15 selected from the group consisting of:
(a) 1,3-cyclic propandiol phosphate-5-oleoyl;
(b) 1,3-cyclic propandiol phosphate-5-benzyloxy;
(c) 1,3-cyclic propandiol phosphate-5-benzylamino;
(d) 1,3-cyclic propandiol phosphate-5-caproylamido;
(e) 1,3-cyclic propandiol phosphate-2-benzyloxy;
(f) 1,3-cyclic propandiol phosphate-2-acetyloxy;
(g) 1,3-cyclic propandiol phosphate-2-methylamino;
(h) 1,3-cyclic propandiol phosphate-5-glycine ethylester;
(i) 2-dimethylamine ethyl ester 1,3-cyclic propanediol phosphate;
(j) 1,3-cyclic propanediol phosphoamidate;
(k) 1,3-cyclic propanediol N-ethyl phosphoamidate;
(l) 1,3-cyclic propanediol phosphoamidate glycine ethylester;
(m) 2-benzyloxy 1,3-chloropropanediol phosphate;
(n) 2-caproimido 1,3-chloropropanediol phosphate;
(o) 5-amino-5-hydroxymethyl-2-oxo-2λ5-[1,3,2]dioxaphosphinan-2-ol; and
(p) 5-nitro-5-hydroxymethyl-2-oxo-2λ5-[1,3,2]dioxaphosphinan-2-ol;
or a pharmaceutically acceptable salt thereof.

20. A pharmaceutical composition comprising a pharmaceutical acceptable carrier and, as an active ingredient, a compound (I) in accordance with claim 15.

21. A pharmaceutical composition according to claim 20, for promoting neural activity.

22. A pharmaceutical composition according to claim 21, wherein said neural activity is selected from the group consisting of promotion of neuronal outgrowth, promotion of nerve growth, provision of dopaminotrophic supporting environment in a diseased portion of the brain, prevention of nerve degeneration and nerve rescue.

23. A pharmaceutical composition according to claim 22, wherein said neuronal outgrowth is axonal growth or axonal branching.

24. A pharmaceutical composition according to claim 20, for the prevention or treatment of disorders and diseases which can be prevented or treated by activating neural cells.

25. A pharmaceutical composition according to claim 22, wherein said disorder and disease are schizophrenia, dementia or disorder resulting from learning disabilities.

26. A pharmaceutical composition according to claim 20 wherein the compound of formula I is selected from the group consisting of
(a) 1,3-cyclic propandiol phosphate-5-oleoyl;
(b) 1,3-cyclic propandiol phosphate-5-benzyloxy;
(c) 1,3-cyclic propandiol phosphate-5-benzylamino;
(d) 1,3-cyclic propandiol phosphate-5-caproylamido;
(e) 1,3-cyclic propandiol phosphate-2-benzyloxy;
(f) 1,3-cyclic propandiol phosphate-2-acetyloxy;
(g) 1,3-cyclic propandiol phosphate-2-methylamino;
(h) 1,3-cyclic propandiol phosphate-5-glycine ethylester;
(i) 2-dimethylamine ethyl ester 1,3-cyclic propanediol phosphate;
(j) 1,3-cyclic propanediol phosphoamidate;
(k) 1,3-cyclic propanediol N-ethyl phosphoamidate;
(l) 1,3-cyclic propanediol phosphoamidate glycine ethylester;
(m) 2-benzyloxy 1,3-chloropropanediol phosphate;
(n) 2-caproimido 1,3-chloropropanediol phosphate;
(o) 5-amino-5-hydroxymethyl-2-oxo-2λ5-[1,3,2]dioxaphosphinan-2-ol; and
(p) 5-nitro-5-hydroxymethyl-2-oxo-2λ5-[1,3,2]dioxaphosphinan-2-ol;
or a pharmaceutically acceptable salt thereof.

27. A method of treating disorders and diseases which can be prevented or treated by activating neural cells comprising administering to the individual in need a therapeutically effective amount of a compound in accordance with claim 15.

28. A method according to claim 27, wherein said neural activity is selected from the group consisting of promotion of neuronal outgrowth, promotion of nerve growth, provision of dopaminotrophic supporting environment in a diseased portion of the brain, prevention of nerve degeneration and nerve rescue.
